(19) United States
(12) Patent Application Publication
(10) Pub. No.: US 2021/0262433 A1
(43) Pub. Date: Aug. 26, 2021

(54) Rotary Device with Stacked Sail Configuration

(71) Applicant: David Mastel, Phelan, CA (US)

(72) Inventor: David Mastel, Phelan, CA (US)

(21) Appl. No.: 17/315,308

(22) Filed: May 9, 2021

Related U.S. Application Data
(63) Continuation of application No. PCT/US2019/060655, filed on Nov. 9, 2019.
(60) Provisional application No. 62/758,338, filed on Nov. 9, 2018.

(51) Int. Cl. F03D 1/06

(52) U.S. Cl. CPC F03D 1/0625; F05B 2240/40; F05B 2250/25; F05B 2210/16

(57) ABSTRACT

A rotary device that converts a linear fluid movement to a rotational fluid movement to generate power includes a front sail and a plurality of sail pairs situated around a shaft. In some embodiments, each of the sail pairs includes oppositely disposed sails in the same longitudinal plane. In some embodiments, the front sail and/or each sail of the sail pairs can include a flap and/or an airfoil.

### CROSS-REFERENCE TO RELATED APPLICATIONS

This application is a continuation of International application No. PCT/US2019/060655 filed on Nov. 9, 2019 entitled “Rotary Device with Stacked Sail Configuration” which, in turn claims priority benefits from U.S. Provisional Application Ser. No. 62/758,338 filed on Nov. 9, 2018, also entitled “Rotary Device with Stacked Sail Configuration”. The '655 and '338 applications are each hereby incorporated by reference herein in their entireties.

### FIELD OF THE INVENTION

The present application relates to a rotary device that can be used in turbines, propellers, impellers, and fans. More particularly, the present application relates to a rotary device which utilizes an overlapping and/or stacked sail configuration to convert a linear fluid movement to a rotational fluid movement to generate power or convert a rotational fluid movement to a linear, compressed or uncompressed fluid movement for the purpose of motion through kinetic energy translation.

Mankind has used various machines to harvest the power in air and water currents since ancient times. Prior devices have included horizontal as well as vertical shaft devices; these devices have included small as well as large numbers of blades of various shapes and sizes.

Electricity-generating wind turbines have appeared around the world within the last few hundred years. These turbines often include a horizontal axis wind turbine typically equipped with two or three blades, Holland 4 blade, a main rotor shaft and electrical generator mounted atop a tower; a vertical axis turbine with curved blades, a vertically oriented rotor shaft, and a generator near the ground, and a second vertical axis-type turbine similar to the first but with straight as opposed to curved blades.

While prior wind turbines have achieved widespread use, they suffer numerous disadvantages, including less than optimal efficiency and a high cost of manufacturing per watt of power production. In addition, horizontal axis turbines must point into the wind to function, requiring wind sensors and servo motors to achieve proper orientation, 360° longitudinal rotation of the airfoils around a center hub, and, accordingly, a higher dynamic loading on the blades.

Vertical axis turbines function better in variable wind conditions; however, they suffer many disadvantages due to the 360° longitudinal rotation of the airfoils around a center hub which requires higher dynamic loading on the blades. In addition, the suffer from drag as the blade circles back into the wind past the center axis.

Embodiments of an apparatus for harvesting the energy in air or water currents to generate energy, such as mechanical and/or electrical energy is disclosed in U.S. Ser. No. 15/853,749 filed on Dec. 23, 2017, entitled “Current Powered Generator Apparatus”, PCT Patent Application Serial No. PCT/US16/39113 filed on Jun. 23, 2016, entitled “Current Powered Generator Apparatus”, and U.S. Ser. No. 62/183,707 filed on Jun. 23, 2015, also entitled “Current Powered Generator Apparatus”. The '749, '707, and '113 applications are hereby incorporated by reference herein in their entireties.

A rotary device that uses an overlapping and/or stacked sail configuration can be used to overcome the disadvantages of existing turbine designs by reducing eddy currents, centripetal losses, rotational losses, counterproductive lift losses, reduced pre-entry fluid stagnation, and/or undesirable propeller cavitation. Such a configuration creates a push-pull fluid movement through the rotors thereby continuing linear momentum while reducing frictional losses.

In at least some embodiment, such a design can be used in turbines to convert a linear fluid movement to a rotational fluid movement to generate power whether compressed (such as air) or uncompressed (such as water). In at least some embodiment, the design can be used in power-driven impellers and propellers to convert rotational fluid movement to near-linear, linear, compressed or uncompressed fluid movement for the purpose of efficient motion translation.

### SUMMARY OF THE INVENTION

A rotary device that converts a linear fluid movement to a rotational fluid movement to generate power can include a front sail, a plurality of sail pairs situated behind the front sail, and a shaft, wherein the front sail and the sail pairs are connected to the shaft in a stacked sail configuration.

In some embodiments, the plurality of sails includes a first sail pair, a second sail pair, a third sail pair, and a fourth sail pair. Each sail pair can include two sails oppositely disposed in the same longitudinal plane.

In some embodiments, the stacked sail configuration can be created by positioning the sails around the shaft of the rotary device in the following order: front sail; first sail pair; second sail pair; third sail pair; and fourth sail pair.

The fluid can be a compressible or incompressible fluid.

In some embodiments, the sails of the rotary device can have an irregular trapezoid shape with a distal end that is longer in length than the proximal end.

In some embodiments, the front sail and/or each sail of the first, second, third, or fourth sail pairs can include an airfoil situated essentially perpendicular to and extending the length of the distal end of each sail.

In some embodiments, the front sail and/or each sail of the first, second, third, or fourth sail pairs can include a tapered flap situated essentially perpendicular to and extending a portion of the length of a side of each sail.

In some embodiments, the diameter of the rotary device can be 38 inches.

In some embodiments, the sails of the rotary device are configured to overlap.

In some embodiments, the distal end of the front sail can have a leading edge that projects toward the front of the rotary device and a trailing edge that projects toward the rear of the rotary device, relative to the z-axis of the front sail.

In some embodiments, the distal end of each sail of the first, second, third, and/or fourth sail pair can have a leading edge that projects toward the front of the rotary device and a trailing edge that projects toward the rear of the rotary device, relative to the z-axis of each sail.

### BRIEF DESCRIPTION OF THE DRAWINGS

FIG. 1 is a perspective view of a sail.

FIG. 2 is a perspective view of the front of a sail.

FIG. 3A is a perspective view of two sails that overlap in the x-y plane.

FIG. 3B is a second perspective view of the sails of FIG. 3A.

FIG. 4 is a perspective front view of a rotary device with a stacked sail configuration.

FIG. 5 is a rear perspective view of a rotary device with a stacked sail configuration.

FIG. 6A is a front view of a sail configuration that overlaps in the x-y plane.

FIG. 6B is a side view of a stacked sail configuration that overlaps in the y-z plane.

FIG. 6C is a front view of a sail configuration that does not overlap in the x-y plane.

FIG. 6D is a side view of a stacked sail configuration that does not overlap in the y-z plane.

FIG. 7A is side view of another embodiment of a stacked sail configuration that does not overlap in the y-z plane.

FIG. 7B is a view of the z-axis of the sails of FIG. 7A.

FIG. 7C is a simplified view of the z-axis of the front sail of FIG. 7B.

FIG. 8 depicts angles of attachment (fluid collection angles) and radius of curvature values for sails of a rotary device.

FIG. 9 is a perspective view of the back of a rotary device utilizing three sails.

FIG. 10 is a perspective view of the front of a rotary device utilizing three sails.

FIG. 11 is a perspective view of the back of a rotary device utilizing two sail quads.

FIG. 12 is a perspective view of the front of a rotary device utilizing two sail quads.

FIG. 13 is a perspective view of the back of a rotary device utilizing twelve sails.

FIG. 14 is a perspective view of the front of a rotary device utilizing twelve sails.

FIG. 15 is a partial cutaway perspective view of a tunnel thruster utilizing three sails completely retracted into a compartment.

FIG. 16 is a partial cutaway perspective view of a tunnel thruster utilizing three sails partially extended out of the compartment.

FIG. 17 is a partial cutaway perspective view of a tunnel thruster utilizing two three sails completely retracted into a compartment.

FIG. 18 is a perspective view of the front of a rotary device.

FIG. 19 is a perspective view of the back of a rotary device.

### DETAILED DESCRIPTION OF ILLUSTRATIVE EMBODIMENT(S)

At least some embodiments, of the device of the present disclosure avoids many of the disadvantages of prior propeller or turbine designs and provides consistent and reliable harvesting of power in a wider variety of situations such as both lower and higher fluid velocities. Various embodiments of the device can be used to harness energy by changing the linear momentum of laminar and/or turbulent flow of wind (air), water, and/or other fluids into angular or rotational momentum. The total number of sails, the number of sails within a longitudinal placement (the number of sails within a stack), the number of stacks, the z-depth of each sail, the collective z-depth of the device (tightening or widening the sail stacks about the shaft of the device), and/or the movement of the torque moment arm within the sails can be configured for different harvesting speeds requiring higher torque and less RPM or lower torque and higher RPM. It is noted that fluid can refer to wind, water, or other compressible and incompressible fluids.

In some embodiments, the device can be implemented in turbines and operated in a clockwise or counterclockwise rotation to convert a linear fluid movement to a rotational fluid movement to generate power, reducing parasitic losses.

In some embodiments, the device can be implemented in power-driven impellers or propellers and operated in a clockwise or counterclockwise rotation to convert rotational fluid movement to linear, compressed and/or uncompressed fluid movement for the purpose of motion.

In some embodiments, the device can be implemented in fans.

In at least some embodiments, the disclosed sails can utilize lift to shaft rotation, both perpendicular lift around and centripetal lift away, combined as vectoral lift to the rotational axis.

Currently, much of the potential energy in wind currents is centripetally never captured. Additionally, laminar fluid velocity stagnation by the progressive flattening of the propellers toward the distal ends, intended to stop vibration cavitation, translates kinetic energy into counterproductive lift in the z-axis direction. In some embodiments, this causes vortex drag currents that reduce potential energy gains. In at least some embodiments, the disclosed sail design and configuration can generate more power from the same initial energy by improved fluid kinetic energy retention due to the curvature stipulations of the leading and trailing edges of the sails as well as the longitudinal or cupping influence of the sail.

In some embodiments, lift is caused by the pressure differential between: (1) the high-pressure (low-velocity) side of the sail and (2) the low-pressure (high-velocity) side of the sail. Movement of the sail is caused by the high-pressure side moving toward the low-pressure side. Sails can be configured to have a specific directional movement. In some embodiments, a rotational aspect can be introduced into the air flow, resulting in energy loss.

In some embodiments, the different longitudinal placement of sails and/or sail sets in the device creates vacuum and pressure cells that help move air or compressible fluids in the front and then out of the back of the device to prevent, or at least reduce, the stalling, laminar flow disruption, frictional fluid slowing effects, and/or dynamic fluidic disruption experienced in traditional propeller designs.

In some embodiments, during rotation, some or a majority of fluid transfers from the high-pressure front side of each sail to the low-pressure back side of each sail such that the fluid wraps around each sail with increased velocity. In some embodiments, during rotation, fluid circumvents a leading sail and projects into the device, without obstruction, to contact the next sequential sail that is longitudinally set back from the leading sail which effectively accelerates fluid flow to the low and high-pressure sides of the next sail. During rotation, movement and transference of the fluid through the sails create a pressure/expansion combination to increase flow through the device. In this respect, the different longitudinal placement of sails can increase the pressure differential of the sails and the velocity of fluid moving through the device resulting in increased power. As the fluid exits the device, some fluid compresses rearward and some fluid flows centripetally outward in the created lower pressure wake, creating a pressure cell conducive to accepting a continuous flow of fluid with minimized laminar flow disruption. Simultaneously, frictional losses during compression are reduced.

In some embodiments, there exists a circular synergistic effect from (1) the compressed (high-pressure; low-velocity) side of all sails progressively releasing fluid at various depths throughout the device, and (2) the centripetal release of fluid on the non-compressed (low-pressure; high-velocity) side of each sail. During rotation, this synergy allows fluidic movement and compression across the compressed (high-pressure) side of each non-leading sail or sails to be aided by the centripetal fluidic displacement from the non-compressed (low-pressure) side of the preceding sail. This forward intake and rearward release facilitates the non-stalling fluidic attachment of all sails within a device and is referred to as the “jib sail effect”. The jib sail effect within the sail circumference can, in part, maximize, or at least increase, the kinetic energy capture of the device.

In some embodiments, compressed air from the front (high-pressure) side of an anteriorly positioned sail can be passed to the front (high-pressure) side of a posteriorly positioned sail and aid in the compression of fresh, untouched air on the front side of the posteriorly positioned sail. Simultaneously, compressed air from the anteriorly positioned sail can be transferred to the rear (low-pressure) side of the posteriorly positioned sail and undergo centripetal expansion to further create a vacuum to pull additional fluid into the device. Collectively, the transfer of compressed fluid from sail to sail and the movement of fluid from the high-pressure side to the low-pressure side of each sail (where centripetal expansion can occur) can augment (either increase or decrease) the kinetic energy captured in the device.

Existing propeller designs, such as those used in windmills, can have a 125.27 m (411-foot) diameter that is capable of generating 7.5 megawatts of power at 16.1 m/s (36 miles per hour). Propeller designs having a 182.88 m (600 foot) diameter are capable of generating 10 megawatts of power. Typically, as the square footage of the design doubles, the moment arm increases by a factor of ˜1.5 and windswept area increases by a factor of ˜2. Theoretically, a 125.27 m (411 foot) device would be projected to produce upwards of ˜23 megawatts of power at 16.1 m/s (36 miles per hour) based on wind-swept area and moment arm. Therefore, existing propeller designs produce only a fraction (˜⅓) of their theoretical projected power output.

Various embodiments of the disclosed sail design and configuration can produce more power compared to existing propeller designs. In some embodiments, a device with a 0.9652 m (38-inch) diameter can produce 606 watts of power at 36 miles per hour. A device with a 1.93 m (76-inch) diameter can increase the windswept area by a factor of 4 and increase the moment arm by a factor of 2 to produce 4.8 kilowatts of power. A device with a 3.861 m (152-inch) diameter can increase the windswept area by a factor of 8 and increase the moment arm by a factor of 4 to produce 38.7 kilowatts of power.

In some embodiments, a device with a 7.62 m (25 feet) diameter can generate 310 kilowatts of power compared to existing propeller designs which produce ˜10 kilowatts of power at the same diameter.

In some embodiments, a device with a 15.24 m (50 feet) diameter can generate ˜2.5 megawatts of power.

In some embodiments, a device with a 30.48 m (100 feet) diameter and a 55-foot z-depth can generate ˜16 megawatts of power.

In some embodiments, a device with a 45.72 m (150 feet) diameter and a 22.86 m (75-foot) z-depth can produce ˜55 megawatts of power.

The sail orientation can be configured such that the low-pressure side is positioned to utilize higher torque with less counterproductive portions. In some of these embodiments, the sail can capture and shape the laminar flow of the fluid with minimized, or at least reduced, centripetal loss.

Therefore, by increasing engagement and containment of the fluid as it moves through the device, the sail's radius can be smaller because of higher fluidic engagement or contact. In some embodiments, the size and/or z-depth of each sail can change depending on fluid conditions. In some embodiments, the parabolic shape of a sail can change from the leading tip to the trailing tip of the sail.

In some embodiments, during rotation, the device creates a vacuum to pull fluid through the grip of the device while simultaneously pushing fluid out of the exhaust side of the device. Grip is the total device volume available for interaction with a fluid when the device is rotating in a clockwise or counter-clockwise direction and is a function of the total z-depth of the device.

As described above, fluidic containment and compression due to the jib sail effect of the sails occurs within the grip of the device for vectored power capture.

In some embodiments, the grip of the rotary device can be altered by adjusting the z-depth (the depth of a sail from the tip of the leading edge to the tip of the trailing edge) of each sail. In some embodiments, grip can be altered to facilitate controlled cavitation of a fluid.

In some embodiments, the z-depth of each sail can be increased to increase the grip of the device.

In some embodiments, the z-depth of each sail can be decreased to decrease the grip of the device.

In some embodiments, the grip of the device can minimize, or at least reduce laminar flow disruption and/or frictional losses during fluid compression within each sail as the duration of fluid-sail contact is increased.

In some embodiments, the grip of the device facilitates synergistic power capture as fluid is captured within the sail circumference.

The grip of the device can be manipulated by, among other things, altering the total number of sails, the number of sails within a longitudinal placement (the number of sails within a stack), the number of sail stacks, sail dimensions, the z-depth of each sail, and/or the collective z-depth of the device.

In traditional blades or wings, such as those utilizing lift perpendicular to the axis, much of the lift centripetally escapes the end of the propellers. This causes vortex drag currents that reduce potential energy gains. In some embodiments, it is beneficial if the lift is vectorially accumulative between rotational movements and natural centripetal flow, and centripetal lift is contained or controlled from outward flow.

In some embodiments, the disclosed device can minimize, or at least reduce, unwanted sail vibration without limiting the torque from centripetal lift.

In some embodiments, the accumulation of rotational movement and centripetal flow can be accomplished by making the axis of a sail arc from a straight, perpendicular starting point, such as from the shaft. In some embodiments, such a design increases the volume of fluid that can be contained and/or compressed in the outer portion of each sail and provides a vector maximizing summation of power to the shaft of the device by moving both the mass within the grip and the moment arm outward.

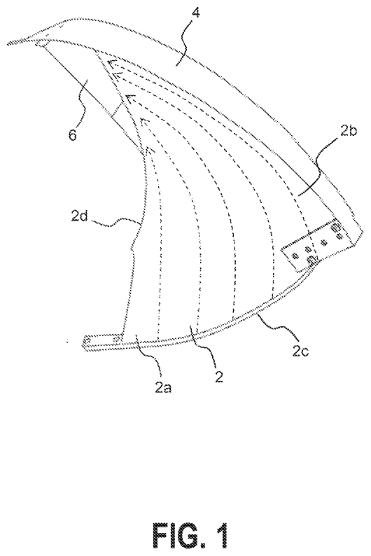

Turning first to FIG. 1, an embodiment of a sail that can be used in turbines, generators, propellers, fans, and/or other propulsion systems is shown. In some embodiments, sail 2 can have an irregular trapezoid shape. In some embodiments, sail 2 can be bent, angled, curved, and/or slanted such that proximal end 2a extends up to and inclusive of 75 degrees forward and/or distal end 2b extends up to and inclusive of 75 backward from the longitudinal axis of sail 2. In some embodiments, proximal end 2a extends up to and inclusive of 75 degrees backward and/or distal end 2b extends up to and inclusive of 75 degrees forward from the longitudinal axis of sail 2.

In at least some embodiments, the curved configuration of sail 2 captures fluids on leading edge 2c and redirects the fluid from full flow to two-thirds outside flow on the sail, thereby transitioning the movement of the fluid from linear to angular. Fluid exits from sail 2 from trailing edge 2d (fluid movement indicated by the arrows in FIG. 1).

In some embodiments, the fluidic movement shown in FIG. 1, with fluid moving toward distal edge 2d of sail 2, can increase the torque produced by a rotary device and subsequently be used to power a generator or as a collection device.

In some embodiments, such as when sail 2 is incorporated into engine driver applications, the curved sail configuration can function to reduce the torque required to drive the rotational movement of a fluid to move a device propelled by a linear movement.

In at least some embodiments, the shape of sail 2 can better contain and/or compress fluids, as compared to existing propeller or turbine designs, by reducing the amount of escaped fluid during rotation. In some embodiments, sail 2 can prevent, or at least reduce, the fluidic disruption that depletes the effective surface contact area seen in existing propeller and turbine designs.

Sail 2 can be made out of suitable materials including, but not limited to, sheet aluminum, cotton canvas, carbon-fiber, steel, sintered metal, fiberglass or composites thereof. In some embodiments, sail 2 can be made by injection molding or 3D printing.

In some embodiments, sail 2 can include airfoil 4 that extends at least a portion of the length of distal end 2b of sail 2. In some embodiments, airfoil 4 can be situated essentially perpendicular to sail 2. In at least some embodiments, airfoil 4 extends the entire length of distal end 2b. In some embodiments, the offset of airfoil 4 from distal end 2b can be between, and inclusive of, 2-180 degrees. In some embodiments, such as, but not limited to, a two-sail device, the offset of airfoil(s) 4 can be at least 180 degrees from the distal end of at least one sail. In some embodiments, such as, but not limited to, a four-sail device, the offset of airfoil(s) 4 can be at least 90 degrees from the distal end of at least one sail. In some embodiments, such as, but not limited to, an eight-sail device, the offset of airfoil(s) 4 can be at least 45 degrees from the distal end of at least one sail.

In some embodiments, a part of airfoil 4 can maximize, or at least increase, torque.

In some embodiments, airfoil 4 can morph into a shape configured to utilize both changing fluid speeds and pressures. In at least some embodiments, airfoil orientation can improve fluid retention and/or compression and overcome stalling by producing higher torque.

In some embodiments, airfoil 4 can morph from a spinnaker configuration in low fluid conditions to a flattened and taut foil in high fluid conditions. In some embodiments, this morphing can be controlled by rotational springs, which can be activated by moment arm pressures as current speeds and lift increased. In this way a morphing foil can be self-regulating.

Airfoil 4 can be made of any number of segments or from a single piece. Airfoil 4 can be made from, but not limited to, aluminum, cotton canvas, and/or carbon fiber.

In some embodiments, sail 2 can include flap 6. In some embodiments, flap 6 can extend at least a portion of the length of side 2d of sail 2. In some embodiments, flap 6 can be situated essentially perpendicular to side 2d. In some embodiments, flap 6 is tapered or configured to slope downward from the distal portion to the central portion of sail 2.

In some embodiments, flap(s) 6 can be added as a safety measure to create stalling and/or flow restriction over a predetermined RPM threshold.

In some embodiments, airfoil 4 and/or flap 6 are permanently affixed to sail 2. In other embodiments, airfoil 4 and/or flap 6 are removable. In some embodiments, such as those created by injection molding or casting, airfoil 4 and/or flap 6 are continuous with sail 2.

The sail design illustrated in FIG. 1 can be implemented into various turbine, propeller, impeller, and/or fan designs including, but not limited to, the illustrative embodiments described below.

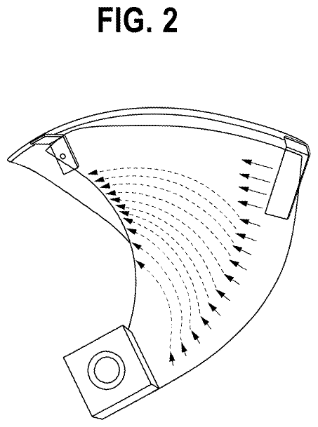

FIG. 2 is a drawing of a single sail mounted on a shaft.

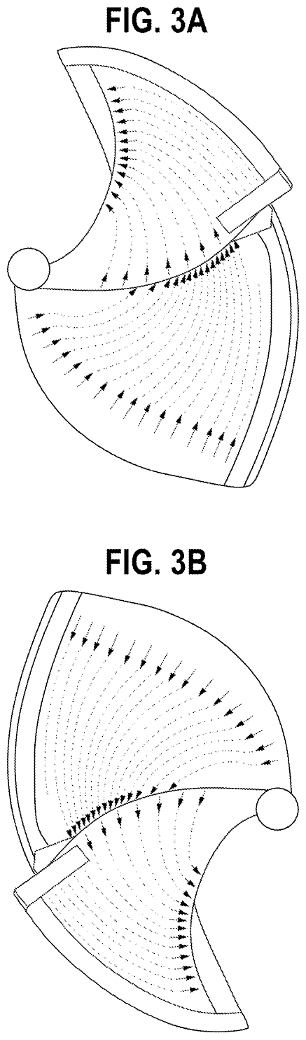

Turning now to FIGS. 3A-3B, two curved sails attached to a shaft are shown. In some embodiments, sails can be arranged to overlap in the x-y plane and/or in the y-z plane. In some embodiments, sails can be arranged in a stacked configuration such that the proximal end of each sail terminates at a different distance (in an independent longitudinal plane) from the front of the shaft.

In some embodiments, the proximal end of each sail can be attached to the shaft by a single attachment point. In other embodiments, the proximal end of each sail can be attached to the shaft by more than one attachment point. In some embodiments, sails are continuous with the shaft.

In some embodiments, the length of a sail can be 19 inches from the center of the shaft to the tip of the leading edge of the distal end of the sail (in Cartesian coordinates). In some embodiments, the height can be 9 inches from the center of the shaft to the tip of the distal edge of the sail (in Cartesian coordinates).

In some embodiments, distance A and/or B of each sail in a rotary device can be the same.

In some embodiments, distance A and/or B of each sail in a rotary device can be different.

In some embodiments, arms can be used to radially bow the sails of the device in the z-plane of the device to adjust the curvature and depth of the sails. In some embodiments, the bow of the sails can be set without the use of arms.

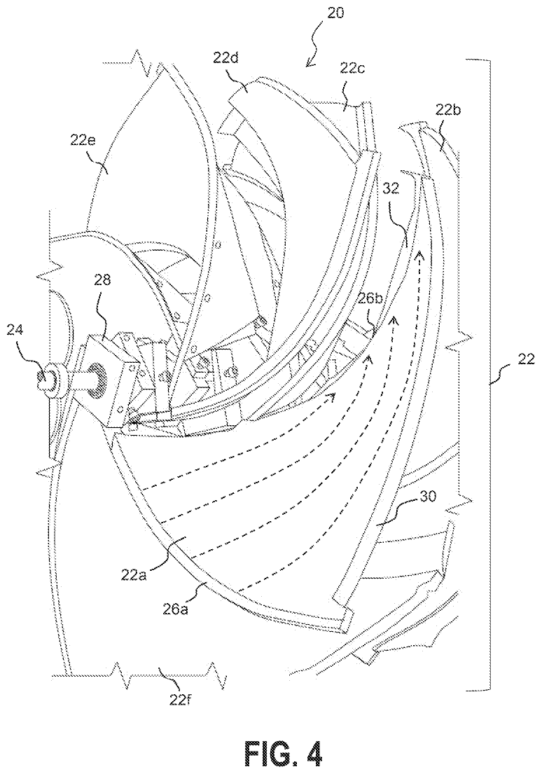

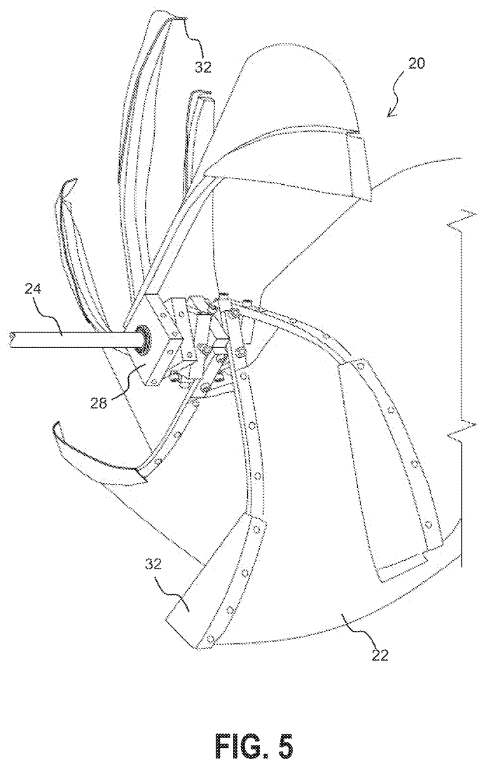

FIGS. 4 and 5 illustrate embodiments of a device, implementing the sail design of FIG. 1, that can be used in turbines, generators, propellers, and/or other propulsion systems. Device 20 can include a plurality of sails 22 surrounding shaft 24.

In some embodiments, sails can be configured as pairs with a first sail oppositely disposed (180 degrees) from a second sail such that each sail in the pair resides in the same longitudinal plane. Sail pairs can be used to make various even-numbered sail systems. In some embodiments, sail pairs can make a 2, 4, 6, 8, 10, 12, 14, or 16 sail system. Designs utilizing more than 16 sails can also be created.

In some embodiments, sails can be configured as triplets with a first sail, a second sail, and a third sail with each sail disposed 120 degrees from its leading or trailing sail. In these embodiments, sail triplets can be used to make various odd- or even-numbered sail systems. In some embodiments, sail triplets can make a 3, 6, 9, or 12 sail system. In some embodiments, including the embodiment illustrated in FIG. 5, device 20 can include a single, foremost sail 22a (that is, lacking an oppositely disposed sail). In some embodiments, remaining sails 22 can also be single sails. In some embodiments, remaining sails 22 can be sail pairs or sail triplets.

In some preferred embodiments, such as those intended for hydroelectric applications, device 20 can include 12 sails (not all sails shown). In these embodiments, device 20 can perform 2 full 360-degree revolutions.

Sails and/or sail pairs can be welded or mounted to attachment piece 28 that includes a central aperture. Shaft 24 can be inserted through the central aperture of each piece 28, depending on the desired sail number, to assemble device 20.

In some embodiments, sails and/or sail pairs can be directly mounted to shaft 24 or other suitable hub source.

In at least some embodiments, the sails and hub are one continuous piece made by injection molding or casting.

In some embodiments, individual sails, sail pairs, triplets, or other suitable multiplets can be attached such that the proximal end of each individual sail or sail pair exists in the same vertical or horizontal plane. In some preferred embodiments, the proximal end of each sail, sail pair, or sail triplet can be stacked along the length of the shaft such that each sail, sail pair, or sail triplet terminates at a different distance from the front of device 20 (hereinafter referred to as a “stacked sail configuration”).

In at least some embodiments, this stacked sail configuration of device 20 can increase the angular velocity, stall torque, and RPM of the device. In some embodiments, as angular velocity increases, sail overlap and/or underlap in the x-y plane and/or y-z plane can be adjusted to engage fluid within the grip of device 20. In some embodiments, the stacked sail configuration creates a vacuum effect to increase the amount of fluid collected, retained, and/or compressed by device 20 and therefore increase the power-generating capability (horsepower) of the device. The stacked sail configuration can lower the pressure on the back of each sail facilitating fluid transfer to the next sail while simultaneously allowing new compression interaction of untouched air within the grip, and ultimately increasing torque and RPM and reducing stalling and frictional losses.

In some embodiments, device 20 can have a single foremost sail or sail pair with the sail or sail pair positioned behind the foremost sail in the stacked sail configuration.

In some embodiments, such as those used for wind, device 20 can include 8 sails with 4 longitudinal placements (a sail pair within each longitudinal placement or stack) on the shaft. In some embodiments, such as those used for wind, device 20 can include 9 sails with 3 longitudinal placements (a sail triplet within each longitudinal placement). In some embodiments, such as those used for wind, device 20 can include 8 sails with two longitudinal placements (a sail quad within each longitudinal placement) on the shaft.

In some preferred embodiments, such as those used for water, device 20 can include a foremost sail with trailing sails each in a separate longitudinal placement along the shaft.

Device 20 can be used to change the linear momentum of the laminar and/or turbulent flow of wind (air), water, and/or other compressible and incompressible fluids into angular or rotational momentum to generate power.

In some embodiments, device 20 can be used to contain and/or compress fluids. In some embodiments, the design of device 20 can better retain fluids as compared to traditional propeller or turbine designs, by reducing the amount of escaped fluid during rotation while transforming the fluid energy from centripetal vectors and perpendicular vectors to a combined rotational vector.

In some embodiments, sails 22 of device 20 can be of various dimensions. In some embodiments, each sail 22 can have the same dimensions. In other embodiments, sails 22 can be of varying dimensions. The diameter and/or z-depth of device 20 can be of various dimensions. In some embodiments, the z-depth of sails 22 can vary.

In some embodiments, the design of sails 22 and/or the stacked sail configuration can optimize, or at least increase, performance of device 20 due to changing fluid speeds and pressures. This allows device 20 to utilize both the centripetal lift away from the central shaft as well as perpendicular lift while converting the linear movement of a fluid to rotational RPM and torque.

The stacked sail configuration of device 20 can be used to create productive lift and/or frictional drag (that is lift and/or drag that generates more energy) and/or to reduce counterproductive lift and/or drag. In some embodiments, sails 22 are configured to receive lift and/or drag in multiple directions.

In some embodiments, the size and/or shape of each sail 22 and/or the arrangement of the sails can dictate the amount of fluid compressed by device 20 and therefore control the rotational speed of and power-generating capacity of device 20.

In some embodiments, each sail 22 of device 20 can include airfoil 30 and/or flap 32.

In some embodiments, airfoil 30 can improve the rotational lift and fluid compression capacity of device 20. In some embodiments, airfoil 30 increases the angular velocity and stall torque of device 20. Airfoil 30 can prevent, or at least reduce, stall of sails 22 prior to and during rotation.

In some embodiments, performance of device 20 can be enhanced by flap 32. In some embodiments, flap 32 increases the angular velocity, centripetal lift, and stall torque of device 20. Flap 32 can prevent, or at least reduce, stall of sails 22 prior to and during rotation.

In some embodiments, foremost or leading sail(s) 22a can include flap 32. In at least some of these embodiments, remaining sails 22 can include airfoil 30 and/or flap 32.

In some embodiments, foremost or leading sail(s) 22a can include flap 32 and/or airfoil 30. In at least some of these embodiments, remaining sails 22 can include airfoil 30 and/or flap 32.

In some embodiments, improved fluid retention can be achieved, in part, from the addition of airfoil 30 onto sail(s) 22 of device 20.

In some embodiments, the dimensions of airfoil 30 and/or flap 32 can be changed to adjust the amount of fluid captured and/or compressed by device 20.

In some embodiments, flap(s) 32 can be added to a rotary device as a safety measure to create stalling over a predetermined RPM threshold.

In some embodiments, use of airfoil(s) 30 can aid in directing fluids toward the high-pressure (low velocity) side of sail(s) 22 and therefore aid in the transition of fluid from a linear movement to a rotational movement. Such an effect can help reduce stalling of device 20.

In at least some embodiments, device 20 can be attached to a supporting base to form a tower and positioned a predetermined distance above the ground.

In some embodiments, sails 22 overlap such that the leading and/or trailing side of each sail can be partially positioned over the following sail. For example, in some embodiments, leading edge 26a of foremost sail 22a overlaps with sail 22f and trailing edge 26b of foremost sail 22a overlaps with sail 22b. Sail overlap can maximize, or at least increase, the amount of fluid captured and/or compressed by device 20. In some embodiments, such as those intended for use with non-compressible fluids, sails 22 can overlap. In some embodiments, sails 22 overlap by at least 30%. In some embodiments, such as those intended for use with non-compressible fluids, sails 22 can be non-overlapping.

In at least some embodiments, the stacked sail configuration of device 20 can be configured with overlapping sails 22 that prevent visible openings between sails, as seen by an observer facing the front of the device.

In some embodiments, sails 22 can overlap in the x-y plane and/or the y-z plane.

During rotation of device 20, fluid can move from the leading edge to the trailing edge of each sail. In some embodiments, fluid can be transferred to the high-pressure inner surface (front) of the posteriorly positioned sail and to the lower pressure outer surface (rear) of the posteriorly positioned sail. As illustrated in FIG. 4, fluid can enter leading edge 26a of foremost sail 22a and exit from trailing edge 26b (indicated by the arrows). Some fluid from sail 22a transfers to posteriorly positioned sail 22d which also independently captures fluid via its leading edge. In some embodiments, depending on the grip, a portion of the fluid is transferred to the high-pressure inner surface (front) of the posteriorly positioned sail while a portion of the fluid is transferred to the low-pressure outer surface (rear) of the posteriorly positioned sail. In some embodiments, depending on the grip, all of the fluid is transferred to the inner surface of the posteriorly positioned while none of the fluid is transferred to the outer surface of the outer surface of the posteriorly positioned sail. In some embodiments, depending on the grip, none of the fluid is transferred to the inner surface of the posteriorly positioned sail while all of the fluid is transferred to the outer surface of the posteriorly positioned sail.

In some embodiments, the orientation and/or position of sails 22 can be adjustable along the rotational axis, axially and/or in z-depth.

In some embodiments, the bend or angle of the distal and proximal ends of a foremost sail can be the same as the bend or angle of the distal and proximal ends of the remaining (non-leading) sails. In other embodiments, the bend or angle of the distal and proximal ends of a foremost sail can be unique. In some embodiments, the distance between individual sails, sail pairs, sail triplets, etc. in the stacked sail configuration is uniform. In other embodiments, the distance between sails, sail pairs, sail triplets, etc. in the stacked sail configuration is variable.

In some embodiments, device 20 can function as a vertical or horizontal axis turbine. In other embodiments, device 20 can be positioned 0-90° relative to an incoming fluid (diagonally offset).

In some embodiments, device 20 can be used to direct sails in a clockwise or counterclockwise direction depending on the desired application.

In some embodiments, device 20 can be used to compress a compressible fluid with or without a housing element as a propeller from front to back or powered back to front.

In some embodiments, device 20 can be used as an impeller for compressible fluids to generate power or in power-driven devices.

In some embodiments, device 20 can be used to harvest energy from incompressible fluids with or without a housing element.

It will be understood that various parameters of device 20 can be adjusted to create various embodiments suited for high, low, and/or intermediate RPM conditions and applications including deriving power from a linear fluid input or generating a linear fluid flow from a power-driven source.

In some embodiments, flaps 32 and/or airfoils 30 can be configured with tiered holes to reduce sail stall during rotation by aiding in moving fluid from the high-pressure side to the low-pressure side of sail 22. In these embodiments, use of tiered holes creates pressure transfer points through the sail.

In some embodiments, sails 22 can be configured with additional protrusions, flaps, and/or airfoils situated on the front and/or back of the sails. In some embodiments, a select number of sails 22 can have additional protrusions, flaps, and/or airfoils. In some embodiments, all sails 22 can have additional protrusions, flaps, and/or airfoils. In some of these embodiments, additional front and or-rear facing protrusions, flaps, and/or airfoils can extend the longitudinal depth of a sail.

In some embodiments, multiple devices 20 can be stacked, arranged, or otherwise configured to create a multi-device unit. Such units can be used to power buildings.

In some embodiments, device 20 can be housed in a venturi such as, but not limited to, a funneled cone, hourglass, or cowl.

In some embodiments, use of a venturi can accelerate a fluid traveling through device 20.

In some embodiments, the venturi can be configured to create a low-pressure cell or vacuum to exhaust the device and increase air flow velocity.

In some embodiments, the venturi can include a damper or scoop. In at least some of these embodiments, use of a damper or scoop can adjust the pressure and/or power output of the device. In some embodiments, the device can be configured with stalling flaps, foils, and/or openings to modulate the vacuum of the venturi.

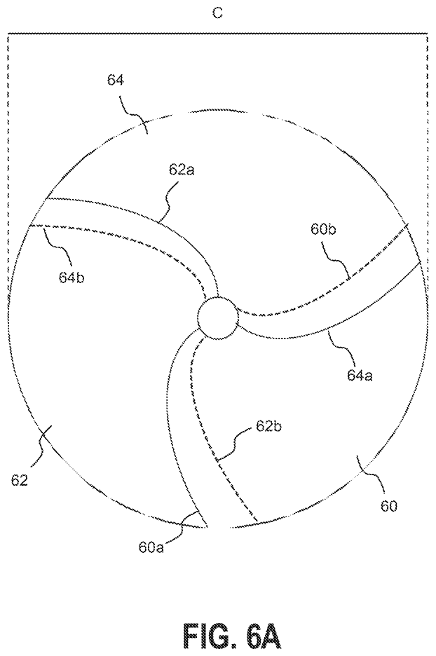

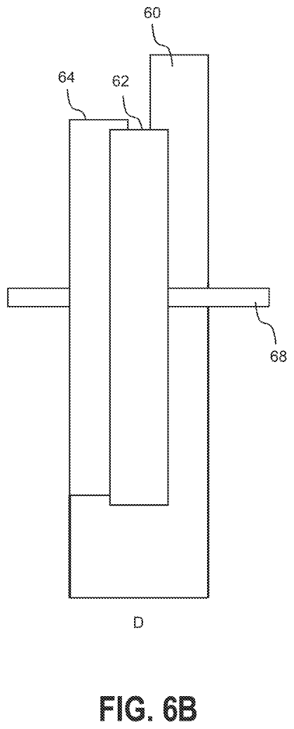

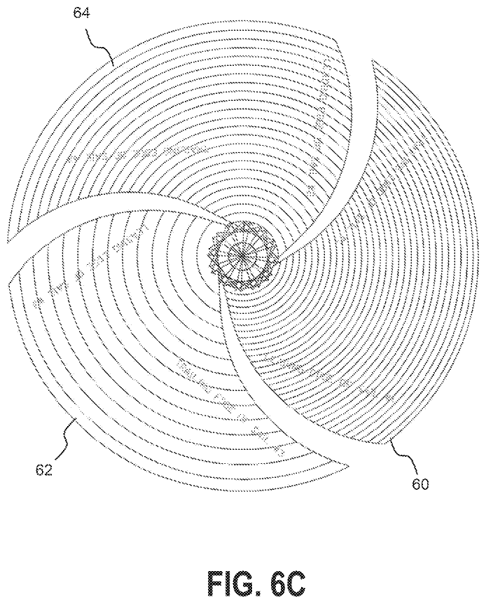

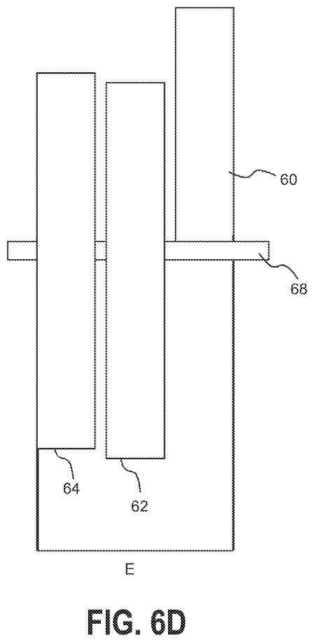

FIG. 6A illustrates a simplified embodiment of a rotary device that demonstrates a sail configuration with overlap in the x-y plane. Sail 60 has leading edge 60a that overlaps with trailing edge 62b of sail 62 (sail underlap indicated by dashed lines). Sail 62 has leading edge 62a that overlaps with trailing edge 64b of sail 64. Sail 64 has leading edge 64a that overlaps with trailing edge 60b of sail 60. In some embodiments, the leading edge of a sail can overlap up to, and inclusive of, 20% and/or the trailing edge of a sail can underlap up to, and inclusive of, 60% relative to the preceding or following sail, respectively.

In some embodiments, diameter C, in the x and y axes, of a rotary device can be 96.52 cm (38 inches).

FIG. 6B is a side view of the three-sails of FIG. 6A showing a stacked sail configuration around shaft 68 with sails 60, 62, and 64 that overlap in the y-z plane.

Width D, as measured from the side profile of the device, can be approximately 33.02 cm (13 inches) from the leading tip of front-most sail 60 to the trailing tip of rear most sail 64.

FIG. 6C illustrates a sail configuration in which the leading and trailing edges of sails 60, 62, and 64 do not overlap in the x-y plane.

FIG. 6D is a side view of the three-sails of FIG. 6C showing a stacked sail configuration around shaft 68 with sails 60, 62, and 64 that do not overlap in the y-z plane.

In some embodiments, sails can overlap and/or underlap in the x-y plane and/or in the y-z plane.

In some embodiments, sail overlap and/or underlap in the x-y plane and/or the y-z plane can be manipulated to adjust the grip of the device.

In some embodiments the overlap and/or underlap of each sail in the x-y and/or y-z plane can be the same between sails of a rotary device.

In some embodiments, the overlap and/or underlap of each sail in the x-y and/or y-z plane can vary between the sails of a rotary device.

In some embodiments, width E, as measured from the side profile of the device, can be approximately 44.2 cm (17.4 inches) from the leading tip of front-most sail 60 to the trailing tip of rear-most sail 64.

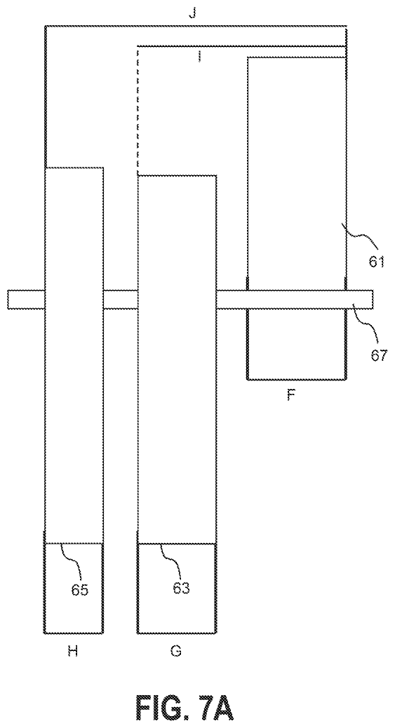

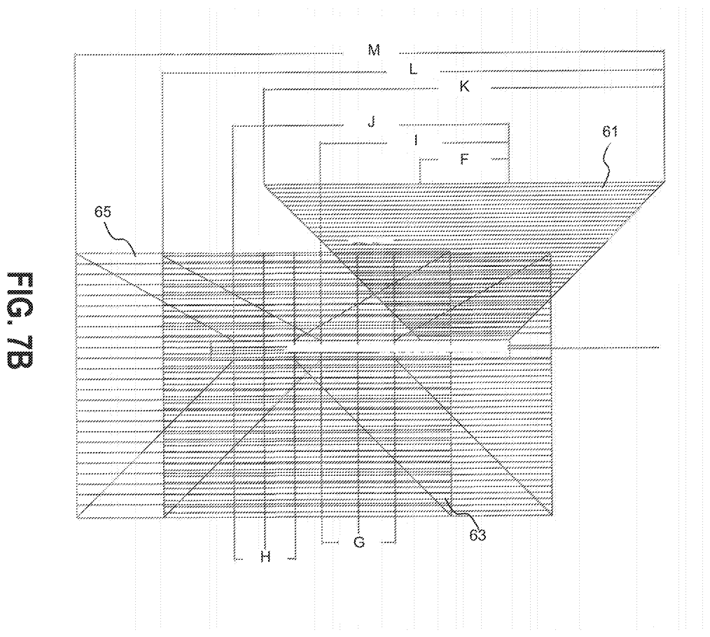

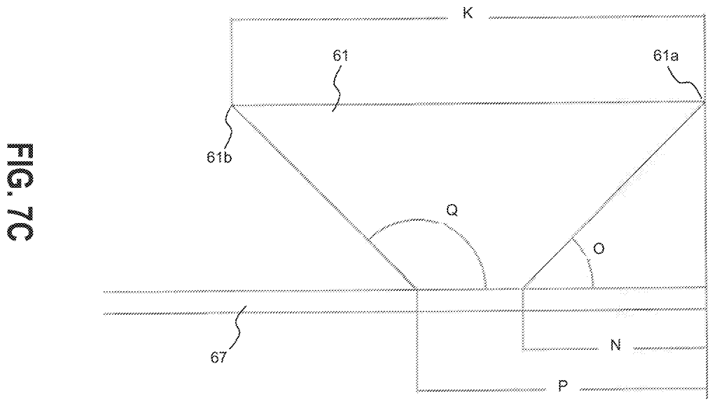

FIG. 7A is a side view of another embodiment of a non-overlapping stacked sail configuration of three sails 61, 63, and 65 around shaft 67.

In some embodiments, width F, as measured from the side profile of the device, can be approximately 26.16 cm (10.3 inches) from the leading to the trailing tip of leading sail 61.

In some embodiments, width G, as measured from the side profile of the device, can be 21.59 cm (8.5 inches) from the leading to the trailing tip of sail 63.

In some embodiments, width H, as measured from the side profile of the device, can be approximately 17.78 cm (7.0 inches) from the leading to the trailing tip of sail 65.

In some embodiments, width I, as measured from the side profile of the device, can be approximately 55.37 cm (21.8 inches) from the leading tip of leading sail 61 to the trailing tip of sail 63.

In some embodiments, width J, as measured from the side profile of the device, can be approximately 80.77 cm (31.8 inches) from the leading tip of leading sail 61 to the trailing tip sail 65.

FIG. 7B is a z-depth view of the sails 61, 63, and 65.

In some embodiments, z-depth K of leading sail 61, from the leading tip to the trailing top can be approximately 1.171 m (46.1 inches).

In some embodiments, z-depth L, from the leading tip of leading sail 61 to the trailing tip of sail 63 can be approximately 1.468 m (57.8 inches).

In some embodiments, z-depth M, from the leading tip of leading sail 61 to the trailing tip of sail 65 can be approximately 1.72 m (67.7 inches).

FIG. 7C is a simplified view of the z-depth of leading sail 61 illustrating the forward-projection of leading tip 61a and the rear-projection of trailing tip 61b from the attachment point of sail 61 to shaft 67. In some embodiments, the forward and/or rearward projection of leading tip 61a and trailing tip 61b can be straight. In some embodiments, the forward and/or rearward projection of leading tip 61a and trailing tip 61b can be various degrees of curvature.

In some embodiments, leading tip 61a protrudes toward the front of the device. In other embodiments, leading tip 61a protrudes toward the rear of the device.

In some embodiments, trailing tip 61b protrudes toward the front of the device. In other embodiments, trailing tip 61b protrudes toward the rear of the device.

In some embodiments, the protrusion of the leading and/or trailing tips of each sail can vary between the sails of a rotary device.

In some embodiments, distance N, the distance leading tip 61a protrudes toward the front or rear of the device can be approximately 45.46 cm (17.9 inches). Angle O can be approximately 35 degrees.

In some embodiments, distance P, the distance trailing tip 61b protrudes toward the rear or front of the device can be approximately 71.63 cm (28.2 inches). Angle Q can be approximately 139 degrees.

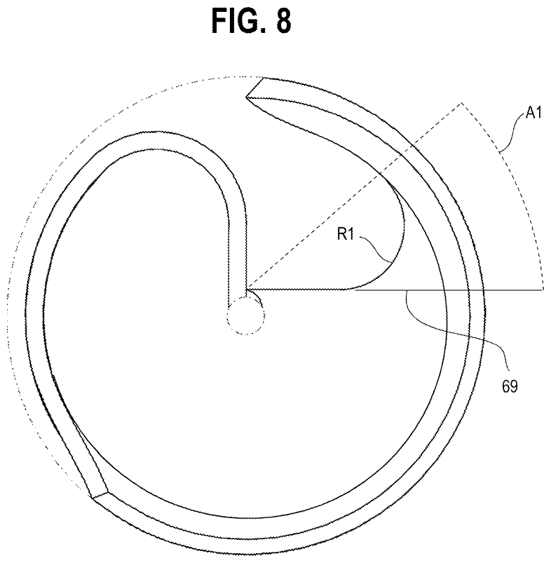

FIG. 8 is a diagram illustrating an angle of attachment (fluid collection angle) and radius of curvature that can be used for sails of a rotary device. A1 refers to the angle of attachment (arc angle) of the distal tip of sail 69 relative to the shaft of a rotary device. In some embodiments, A1 can have a range between, and inclusive of, 3-63°. In some preferred embodiments, A1 can have a range between, and inclusive of, 10-56°. In some more preferred embodiments, A1 can have a range between, and inclusive of, 23-43°. In some even more preferred embodiments, A1 can be 33°.

R1 refers to the radius of curvature of sail 69 as it deviates from the 0° x-axis (with the distal tip of sail 69 being attached at an A1 location described above). In various embodiments, R1 can range from 15.2 cm-40.64 cm (6-16 inches).

In some embodiments, sail 69 curves immediately from the shaft of a rotary device such that curve radius R1 can be approximately 39.62 cm (15.6 inches).

In some embodiments, sail 69 can extend 5.08 cm (2 inches) from the shaft, along the x-axis, and then curve such that R1 can be approximately 35.56 mm (14.0 inches).

In some embodiments, sail 69 can extend 10.6 cm (4 inches) from the shaft, along the x-axis, and then curve such that R1 can be approximately 27.43 cm (10.8 inches).

In some embodiments, sail 69 can extend 15.24 cm (6 inches) from the shaft, along the x-axis, and then curve such that R1 can be approximately 22.86 cm (9.0 inches).

In some embodiments, sail 69 can extend 20.32 cm (8 inches) from the shaft, along the x-axis, and then curve such that R1 can be approximately 19.05 cm (7.5 inches).

In some embodiments, sail 69 can extend 25.4 cm (10 inches) from the shaft, along the x-axis, and then curve such that R1 can be approximately 17.01 cm (6.7 inches).

In some embodiments, manipulation of the angle of attachment and/or the curve radius can adjust the fluidic containment and compression of the grip of a rotary device.

In some embodiments, such as the one shown in FIG. 8, use of parabolic shaping of the sail profiles in the Z direction. As the outer circumferential lip is trimmed it becomes a sharp cutting edge. The flaring out of the wing edge allows it to more aggressively gather and force more fluid into its “grip”. This frees the propeller from much of the fluidic drag on the outer skin of the blade as it rotates.

In some embodiments, the angle of attachment and/or the curve radius of a sail can be altered to favor the proximal (near the shaft) side or the distal side of the sail by the shaping of the sail as need for a particular application. For example, a larger radius of curvature moves the pressure more evenly across the sail. A smaller arc angle moves the pressure centrally on the sail. In some embodiments, sails can adopt a straight, spinnaker configuration. In some embodiments, the angle of attachment and/or the curve radius of a sail compress fluid toward the distal side of each sail to generate more torque when the device is used to generate power by converting a linear fluid movement to a rotational fluid movement.

In some embodiments, such as when the rotary device is used as an impeller, the angle of attachment and/or the curve radius aid in fluidic containment and translation fluid over the whole sail such that less torque, and therefore less power, is required to turn the sails when driven by an external power source.

In some embodiments, the angle of attachment and/or the curve radius of each sail in a rotary device can be the same.

In some embodiments, the angle of attachment and/or the curve radius of each sail in a rotary device can be different.

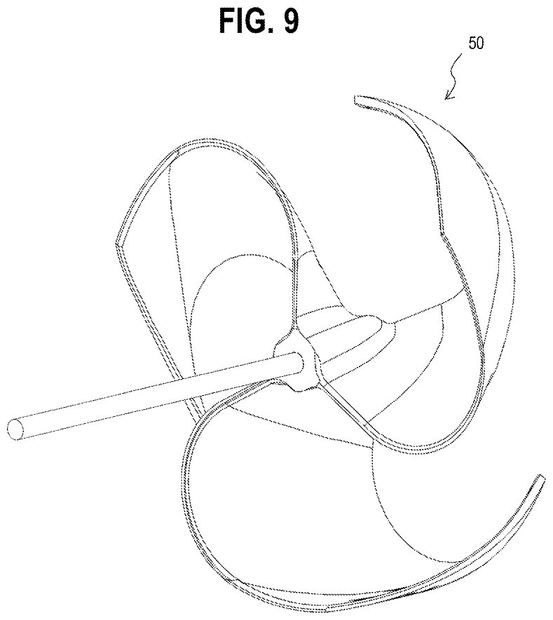

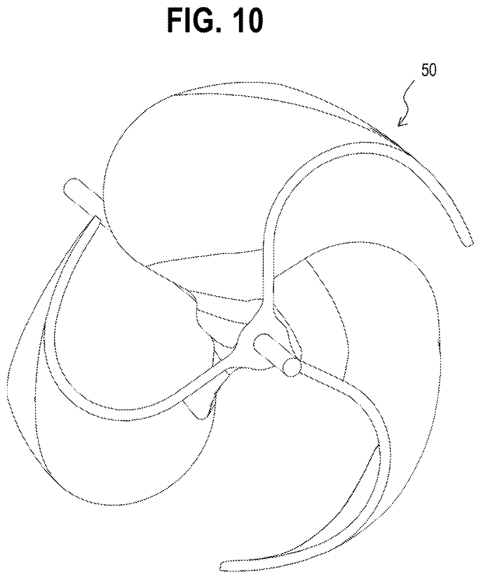

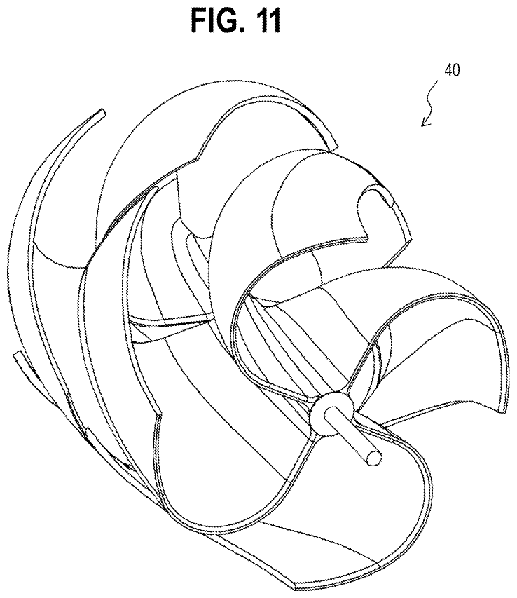

FIGS. 9-10 illustrate device 50 that can include one sail triplet (3 sails total). Each sail triplet includes three sails disposed at 120 degrees in the same longitudinal plane. The sail triple in device 50 can provide as small at 10° of coverage of the total circumference of the device. In some embodiments, device 50 can rotate a fluid approximately 90 degrees per longitudinal triplicate of sails.

Variations of device 50 can be implemented in applications benefitting from higher RPM and lower torque such as, but not limited to, super- or turbo-chargers. Devices with higher RPM and lower torque would utilize less sails (for example a one or two sail configurations). Devices with higher sail numbers, for example between and inclusive of twenty and fifty sails, could be used in super- or turbo-chargers. In some embodiments, such as devices used in jet engines, over one hundred sail configurations can be used.

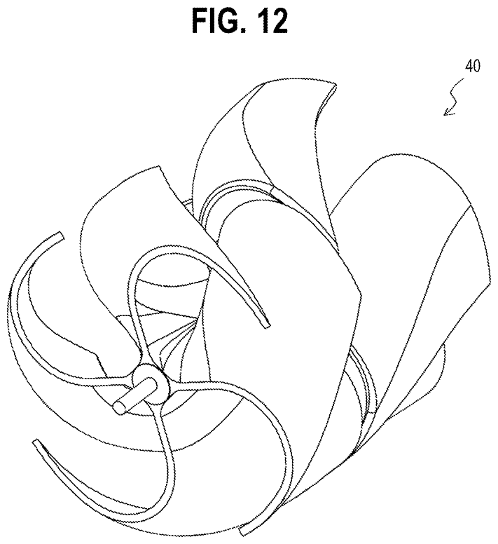

FIGS. 11 and 12 illustrate device 40 that includes 4 sail pairs (8 sails total) arranged in a stacked sail configuration along a shaft with a first sail quad in a first longitudinal plane and second sail quad in a second longitudinal plane. Each sail quad includes two pairs of oppositely disposed (180 degrees) sails in the same longitudinal plane. In some embodiments, device 40 rotates a fluid 210 degrees per longitudinal quad of sails. Device 40 can be implemented in applications requiring higher RPM and lower torque such as, but not limited to, exhaust impellers, super- or turbo-chargers, vehicle turbines as generators or co-generators, and water current generators.

Each sail quad includes four sails arranged 90 degrees apart in the same longitudinal plane. Each sail in device 40 can provide 50° of coverage of the total circumference of the device. In some embodiments, device 40 can rotate a fluid 120 degrees per total volumetric grip of the unit.

In some preferred embodiments, the rotor diameter of device 40, defined by the sails and the shaft, can be 96.52 cm (38 inches). In some preferred embodiments, the distance between the front most sail and the rear most sail (Z-depth) of device 40 can be 31.75 cm 12.5 inches. In some embodiments, the Z-depth can be 0.05-8 times the radius of device 40. Each sail in device 40 can provide 55° of coverage of the total circumference of the device.

As the diameter of device 40 doubles, the surface area increases by a factor of 4, the moment arm increases by a factor of 2, and the power output increases by a factor of 8. In particular embodiments, a 96.5 cm (38-inch) diameter device with a depth of 31.75 mm (12.5 inches) can produce ˜606 Watts of power at 36 mph in the air. Power produced by device 40 was measured using a permanent magnet generator (capable of 4800 Watts at 420 cycles per second (5000 RPM)) wired into a Delta wire configuration on a 20, 000 Watt resister (0.5 Ohms per leg of the 3 phase Delta wire configuration) with voltage (9.5 volts) being measured against a known resistance. The frequency (72 cycles per second) of the permanent magnet generator was calculated based on RPM, number of coils, and number of magnets.

In some embodiments, device 40 with a diameter of 0.965 m (38 inches) and a depth of 0.635 m (25 inches) can produce 700-1100 Watts of power. In some embodiments, device 40 can produce ˜1300 Watts.

In some embodiments, device 40 with a diameter of 96.25 cm (38 inches) and a depth of 31.75 cm (12.5 inches) can have a total power conversion of ˜650 Watts based on a compression factor of 11.1 with approximately 0.304 KG (0.67 lb.) of fluid traveling through device 40 at 16.1 m/s (52.8 ft/s).

In some embodiments, device 40 with a diameter of 96.52 cm (38 inches) and a depth of 96.52 cm (38 inches) can have a total power conversion of ˜1900 Watts based on a compression factor of 16.65 with approximately 0.922 KG (2.03 lb.) of fluid traveling through device 40 at 16.1 m/s (52.8 ft/s). and a total of 15.4 KG (33.94 lb.) of compressed fluid within the volumetric grip.

In some embodiments, device 40 with a diameter of 96.52 cm (38 inches) and a depth of 63.5 cm (25 inches) can have a total power conversion of ˜1300 Watts based on a compression factor of 16.65 with approximately 0.608 KG (1.34 lb.) of a compressible fluid traveling through device 40 at 16.1 m/s (52.8 ft/s) and a total of 10.13 KG (22.30 lb.) of compressed fluid within the volumetric grip.

In some embodiments, device 40 can have a diameter of 96.52 cm (38 inches) and a depth of 2.896 m (9.5 feet). Based on an incompressible fluid traveling 4.023 m/s (9 mph), some of these embodiments can hold 2026.2 KG (4,463 lb.) of fluid within the grip while traveling at 4.023 m/s (13.2 ft/s) to produce 16.3 kilowatt-hours.

In some embodiments, device 40 can have a diameter of 1.93 m (76 inches) and a depth of 5.791 m (19 feet). Based on an incompressible fluid traveling at 4.023 m/s (9 mph), some of these embodiments can hold 16,182.4 KG (35,644 lb.) of fluid within the grip while traveling at 4.023 m/s (13.2 ft/s) to produce 130.8 kilowatt-hours.

In some embodiments, device 40 can have a diameter of 3.86 m (152 inches) and a depth of 11.58 m (38 feet). Based on an incompressible fluid traveling at 4.023 m/s (9 mph), some of these embodiments can hold 128,860 KG (283,832 lb) of fluid within the grip while traveling at 4.023 m/s (13.2 ft/s) to produce 1.4 megawatt-hours.

In some embodiments, device 40 can have a diameter of 7.721 m (304 inches) and a depth of 23.165 m (76 feet). Based on an incompressible fluid traveling at 4.023 m/s (9 mph), some of these embodiments can hold 1,036,268.2 KG (2,282,529 lb) within the grip while traveling at 4.023 m/s (13.2 ft/s) to produce 8.379 megawatt-hours.

In some embodiments, device 40 can have a diameter of 15.433 m (608 inches) and a depth of 46.33 m (152 feet deep). Based on an incompressible fluid traveling at 4.023 m/s (9 mph), some of these embodiments, can hold 8,288.693.5 KG (18,256,990 lb.) within the grip while traveling at 4.023 m/s (13.2 ft/s) to produce 67 megawatt-hours.

In some embodiments, device 40 can have a diameter of 30.48 m (1200 inches) and a depth of 30.48 m (100 feet). Based on an incompressible fluid traveling at 9 mph, some of these embodiments, can hold 21,247,200 KG (46,800,000 lb.) within the grip while traveling at 4.023 m/s (13.2 ft/s) to produce 171.8 megawatt-hours.

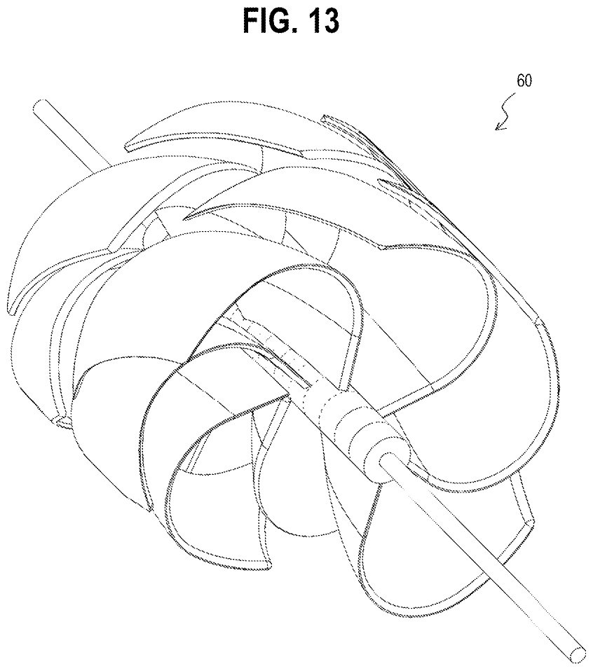

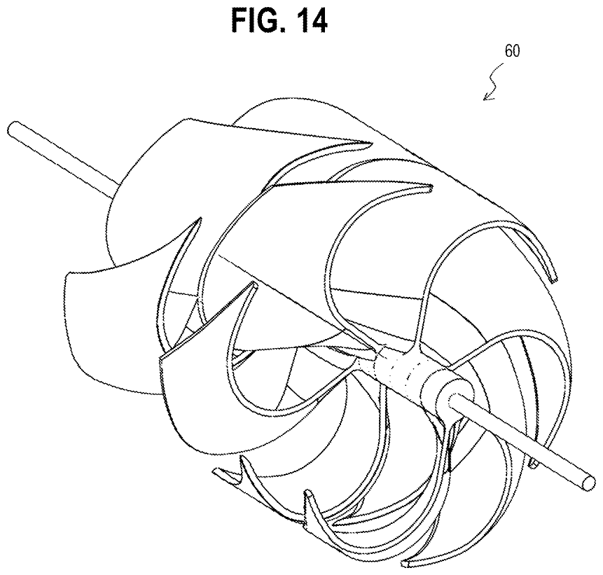

FIGS. 13-14 illustrate device 60 that can include a single lead sail and 11 additional non-leading sails arranged in a single longitudinal plane. In some embodiments, device 60 can be arranged as a double helix configuration to provide 720 degrees of rotation. Each sail in device 60 can provide 72° of coverage of the total circumference of the device.

In some embodiments, device 60 can have a rotation frequency of approximately 3500 RPM.

In some embodiments, device 60 can include a single lead sail and 5 additional sails arranged in a single longitudinal plane. In some embodiments, device 60 can be arranged as a single helix configuration to provide 360 degrees of rotation.

In at least some embodiments, the linear flow of device 60 can be approximately 15.85 m/s (52 ft/s).

Contemplated below are particular applications for embodiments of devices illustrated in the figures and derivations thereof.

In some embodiments, the device can be connected to a suitable power source such as an engine to function as an impeller or propeller to drive devices through the air or water. In some embodiments, the device can be rotated through an engine, steam turbine, gearbox, transmission, or hydraulic motor.

In some embodiments, the device can be used to harvest power from rivers, oceans, hydroelectric dams, and waterfalls.

In some embodiments, the device can be configured for use as a wind and/or air propeller or impeller.

In some embodiments, the device can be used in hovercrafts, helicopters, planes, watercraft impellers, super chargers, turbo chargers, jet engine impellers.

In some embodiments, the sail design can be incorporated into a helicopter blade to counter the rotation of the fuselage.

In some embodiments, the device can be incorporated into a water vessel, such as a ship, or an aircraft, to control yaw, lift, tack and/or steer.

In some embodiments, the device can be used as a supercharger compressor or a chiller compressor.

In some embodiments, a first device, rotating in the clockwise direction, can be situated on the front of a water vessel and a second device, rotating in the counterclockwise direction, can be situated on the rear of the water vessel.

In some embodiments, a first device, rotating in the counterclockwise direction, can be situated on the front of a water vessel and a second device, rotating in the clockwise direction, can be situated on the rear of the water vessel.

In some embodiments, a plurality of devices can be affixed to the front and rear of a water vessel such that the devices pull the water vessel from the front and push the water vessel from the back.

In at least some embodiments, the device can be used as a generator or co-generator for trucks, cars, tractors, land/or sea freight vessels, trailers, buses, trains, planes, jets, boats, submarines, regenerative power stations such as those in an aqueduct system, sail boats, freighters, rockets, pontoons, and/or jet engines by using the kinetic energy of driving the structure through the atmosphere or water and converting back some of that energy to power. The device can drive system components or act as a co-generator to reduce main engine kinetic energy output by ducting the air released from the device to the vacuum area behind the vehicle. In some embodiments, this can reduce the overall drag coefficient.

In some embodiments, the device can serve as a non-engine driven power source for planes such as crop dusters requiring compressed fluids or pumps.

In some embodiments, the device can be used to power compressors, drive train motors, chillers, heat pumps, alternators, generators, synchronous motors, well digging equipment, well pumping equipment, refrigeration units, heating units, heaters, air conditioners, hydrogen generators, hydraulic systems, and/or battery chargers.

In some embodiments, the device can be configured for use in fuel conversion and/or dielectric power generation.

In some embodiments, the device can be used as co-generators in photovoltaic fields, wind farms, and/or various power grids.

In some embodiments, the devices can be constructed as a single monolithic unit. In at least some of these embodiments, this reduces the need for connecting devices such as nuts, bolts, and/or glue which can be areas of weakness and/or decrease the efficiency of the device. In at least some embodiments, at least the sails are a single continuous unit.

In some embodiments, such as when the device is used as a propeller, the device can create a bubble stream through controlled or uncontrolled cavitation when affixed to a water vessel pulling in front of the bow, allowing the vessel to cut through water more smoothly. Such embodiments create a compressible bubble stream for the water vessel to be pulled through. Therefore, instead of the bow or front of the water vessel moving solely through an incompressible fluid, it is able to penetrate a mixture of compressible and incompressible fluids and requires less energy during travel. In some embodiments, controlled cavitation on the rear propeller of a ship can reduce the frictional losses needed to move the vessel through the water making the power push of the vessel more efficient. In some embodiments, the device can pull in various directions to stabilize the deck of the ship.

In some embodiments, the device can eliminate, or at least reduce, the turbo lag of an engine.

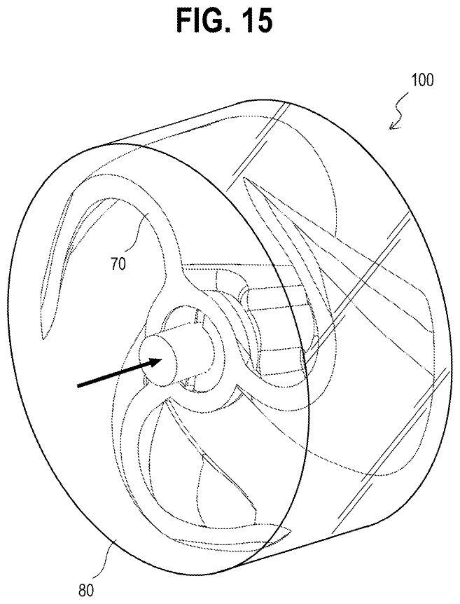

FIG. 15 is a partial cutaway perspective view of tunnel thruster 100 with a sail triplet 70 completely retracted into compartment 80. This setup reduces, if not minimizes, the amount of fluid sail triplet 70 can push through compartment 80.

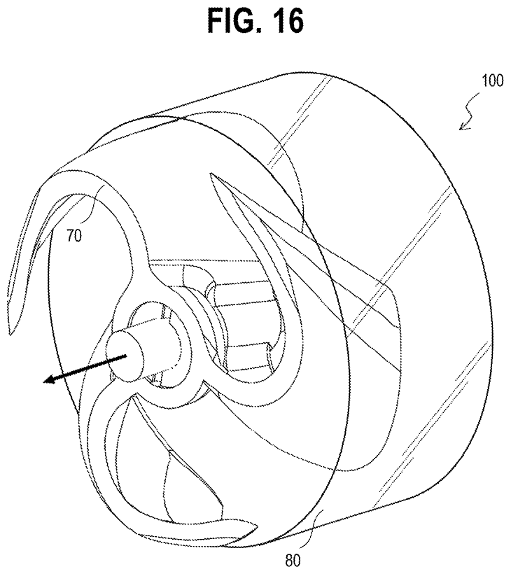

FIG. 16 shows tunnel thruster 100 with sail triplet 70 partially extended from compartment 80, increasing the amount of fluid sail triplet 70 push through compartment 80. Allowing for the amount of sail triplet 70 that is exposed to be adjusted allows for one to customize the amount of fluid flowing through compartment 80. The resulting flow pattern is caused by the spiral rotation (and the pressure relief as sail triplet 70) and the cutting edge forcing more fluid through tunnel thruster 100. Compartment 80 allows sail triplet 70 to do the work of a power propeller when covered by the cylinder and the work of a speed propeller when sail triplet 70 is uncovered.

Compartment 80 also allows the overpowering of sail triplet 70 to make two fluids in a controlled way with cavitating control.

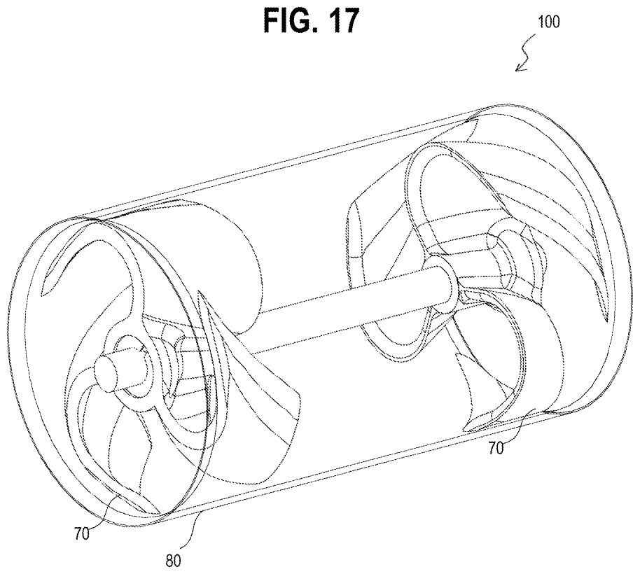

FIG. 17 is a partial cutaway perspective view of tunnel thruster 100 utilizing two sail triplets completely retracted into a compartment. In some embodiments, one sail triplet is stationary. In some embodiments, both sail triplets are stationary.

While shown using sail triplets, any number if sail configurations can be used in the above tunnel thrusters.

In some embodiments, compartment 80 is a sound deadened tube.

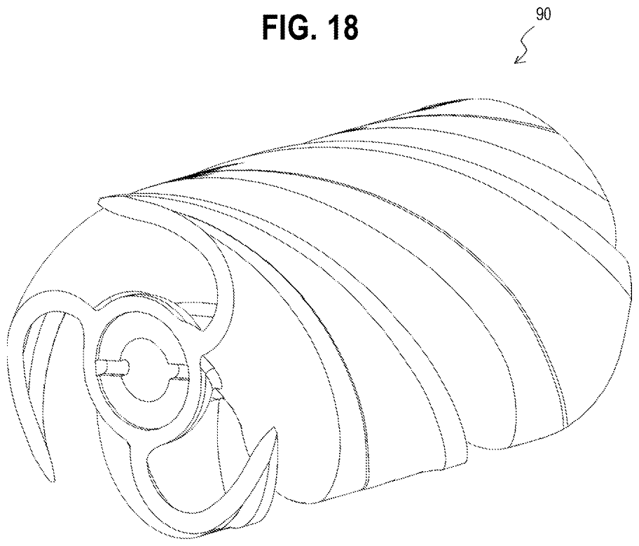

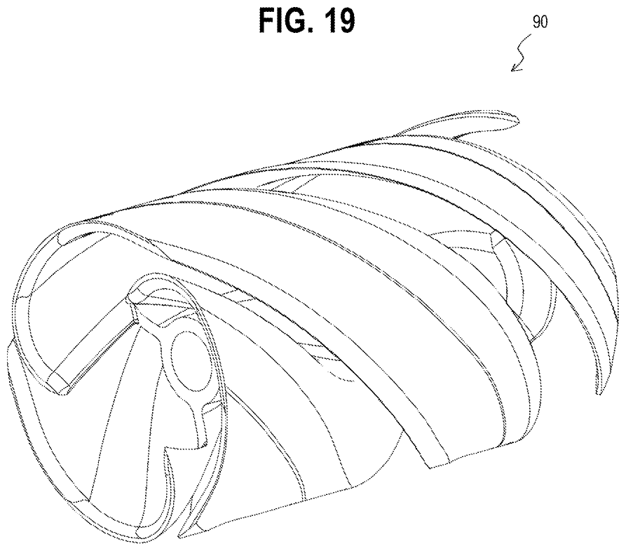

FIG. 18 and FIG. 19 show rotary device 90 that can be used in a tunnel thruster, such as those shown in FIGS. 15-17. Tunnel thrusters using device 90 can work at high speed rotations. Device 90 has longer cutting edges in the Z direction to jamb more fluid into the streams. Device 90 is resistant to uncontrolled cavitating (where the motivating fluid is not kept within the propeller). Instead the fluid is moved continuously starting with the cutting edges in the XY planes and then the spiral long cutting edges continue to add volume. When device 90 is placed within a cylinder, such as compartment 80 in FIG. 17, the controlled cavitating can pull the water apart and make two fluids out of one, a first “air component” is a compressible fluid under the water and a second unaffected portion. Device 90 magnifies the effect of a sail having a smaller cross-section in the front to a larger cross-section and volume in the back. This is also accentuated by a more aggressive cutting edge opening at the entry to a tighter opening toward the back.

Device 90 when used in conjunction with a compartment allows for both variable volume and variable fluids made and controlled within the device for different aspects of fluid piercing capabilities.

As all spinning devices have centripetal release where the fluid wants to fly out of the circle. The use of device 90 with a compartment causes the heavier fluid to displace the lighter fluid moving the water out and leaving most of the bubble centrally located.

In at least some embodiments, the fluid forming aspects of these principles in sail design creates the ability to move fluid more central for powered applications, and more peripheral for power collection applications.

While particular elements, embodiments and applications of the present invention have been shown and described, it will be understood, that the invention is not limited thereto since modifications can be made by those skilled in the art without departing from the scope of the present disclosure, particularly in light of the foregoing teachings.

What is claimed is:

1. A rotary device that converts a linear fluid movement of a linear fluid to a rotational fluid movement to generate power, said rotary device comprising:
(a) a front sail;
(b) a plurality of sail pairs situated behind said front sail; and
(c) a shaft wherein said front sail and said plurality of sail pairs are connected to said shaft in a stacked sail configuration.

2. The rotary device of claim 1, wherein said plurality of sail pairs comprises
(i) a first sail pair;
(ii) a second sail pair;
(iii) a third sail pair; and
(iv) a fourth sail pair.

3. The rotary device of claim 2, wherein said first sail pair comprises a first sail and a second sail oppositely disposed in a first longitudinal plane.

4. The rotary device of claim 3, wherein said second sail pair comprises a third sail and a fourth sail oppositely disposed in a second longitudinal plane.

5. The rotary device of claim 4, wherein said third sail pair comprises a fifth sail and a sixth sail oppositely disposed in a third longitudinal plane.

6. The rotary device of claim 5, wherein said fourth sail pair comprises a seventh sail and an eighth sail oppositely disposed in a fourth longitudinal plane.

7. The rotary device of claim 6, wherein said stacked sail configuration is created by positioning said front sail and said plurality of sail pairs around said shaft in the following order:
(i) said front sail;
(ii) said first sail pair;
(iii) said second sail pair;
(iv) said third sail pair; and
(v) said fourth sail pair.

8. The rotary device of claim 1, wherein said linear fluid is a compressible fluid.

9. The rotary device of claim 1, wherein said linear fluid is an incompressible fluid.

10. The rotary device of claim 1, wherein said front sail and each of said plurality of sail pairs comprises an irregular trapezoid shape with a proximal end and a distal end, wherein said distal end is longer in length than said proximal end.

11. The rotary device of claim 10, wherein said front sail further comprises an airfoil situated essentially perpendicular to and extending the length of said distal end of said front sail.

12. The rotary device of claim 11, wherein said front sail further comprises a tapered flap situated essentially perpendicular to and extending a portion of the length of a side of said front sail.

13. The rotary device of claim 10, wherein each of said sails of said plurality of sail pairs comprises an airfoil situated essentially perpendicular to and extending the length of said distal end of said sails.

14. The rotary device of claim 13, wherein each of said sails of said plurality of sail pairs comprises a tapered flap situated essentially perpendicular to and extending a portion of the length of a side of said sails.

15. The rotary device of claim 7, wherein a diameter of said rotary device is 38 inches (96.5 cm).

16. The rotary device of claim 7, wherein at least a portion of said front sail and each of said first sail and said second sail of said first sail pair, said second sail pair, said third sail pair, and said fourth sail pair are configured to overlap.

17. The rotary device of claim 7, wherein said distal end of said front sail comprises a leading edge and a trailing edge, wherein said leading edge protrudes to a z-axis of said front sail toward the front of said rotary device and said trailing edge protrudes to said z-axis of said front sail toward the rear of said rotary device.

18. The rotary device of claim 17, wherein each of said first sail and said second sail of said first sail pair, said second sail pair, said third sail pair, and said fourth sail pair comprises a leading edge and a trailing edge, wherein said leading edge protrudes to a z-axis of said first sail or said second sail toward the front of said rotary device and said trailing edge protrudes to said z-axis of said first sail or said second sail toward the rear of said rotary device.
